(19) United States
(12) Patent Application Publication
(10) Pub. No.: US 2020/0191245 A1
(43) Pub. Date: Jun. 18, 2020

(54) DIRECTION OF MOTION CHANGING DEVICE

(71) Applicant: Byeong Su KIM, Cheonan-si (KR)

(72) Inventor: Byeong Su KIM, Cheonan-si (KR)

(21) Appl. No.: 16/614,793

(22) PCT Filed: May 4, 2018
(86) PCT No.: PCT/KR2018/005171

§ 371 Date: Nov. 18, 2019

(30) Foreign Application Priority Data
May 19, 2017 (KR) 10-2017-0061925

(51) Int. Cl. F16H 21/16

(52) U.S. Cl. CPC F16H 21/16; B23D 51/16

(57) ABSTRACT

The present invention relates to a direction of motion changing device capable of changing a rotary motion of a driving body to a linear reciprocating motion and, more specifically, to a motion direction changing device in which a rotary shaft which rotates by receiving rotary power from a driving body, such as a motor, is provided with a rotary plate in a tilted shape, and, by means of the rotation of the rotary plate in a tilted state, a linearly reciprocating shaft connected to the rotary plate can linearly reciprocate in the length direction of the rotary shaft.

### TECHNICAL FIELD

The present invention relates to a direction of motion changing device capable of converting a rotary motion of a driving body into a linear reciprocating motion, and more particularly, to a direction of motion changing device in which a rotary plate is provided in a tilted shape on a rotary shaft configured to receive a rotary power of a driving body, such as a motor, to rotate, and a linearly reciprocating shaft connected to the rotary plate linearly reciprocates in a longitudinal direction of the rotary shaft by the rotation of the rotary plate in a tilted state.

### BACKGROUND ART

In general, a device such as a crank structure or a cam structure is known as a representative device (hereinafter referred to as “direction of motion changing device”) for converting a rotary motion into a linear reciprocating motion, or, on the contrary, converting a linear reciprocating motion into a rotary motion.

In addition, the direction of motion changing device described above has implemented an effect of converting a rotary motion into a linear reciprocating motion through a simple structure. However, most of direction of motion changing devices using the crank structure have a problem that a large amount of oil has to be accommodated in a housing in which a crank shaft and a crank arm are accommodated in order to reduce a friction generated at a connection region between the crank shaft and the crank arm, and direction of motion changing devices using the cam structure have a problem that durability of the direction of motion changing device is decreased because an excessive load is generated on a rotation shaft of a driving body that provides the rotary motion.

In particular, recently, among types of the direction of motion changing devices using the crank structure, there has been proposed a direction of motion changing device in which a rotary wheel rotated by a driving body is configured in the form of a bevel gear, an eccentric crank shaft is provided on the rotary wheel, and the crank shaft is connected to a crank arm to reciprocate linearly. Since the above direction of motion changing device is configured such that the rotary wheel and the rotation shaft of the driving body are connected to each other in the form of a bevel gear, a great noise is generated, and a screw thread of the bevel gear is easily damaged when a load is applied to the crank arm.

The following is a representative related art which is related to the direction of motion changing device.

Korean Unexamined Patent Publication No. 10-1999-002010 relates to a rotary motion/linear reciprocating motion changing device and a hydraulic generator using the same. In the hydraulic generator having a cylindrical groove formed at a center of a case, and including a fluid guide member having a plurality of holes communicating with a flow path that communicates with the groove and a pumping device interlocked with a shaft capable of performing a rotary motion in the groove of the case and retaining a rotary power to convert the rotary power into a linear motion so as to generate a hydraulic pressure, the rotary motion/linear reciprocating motion changing device is configured such that one or at least two balls are installed on a cam member integrally coupled with the pumping device, the ball moves along mutually different spiral surfaces when a fluid is sucked and discharged, and the ball is supported by a spring force when the fluid is sucked to alleviate an impact generated upon the suction and the discharge.

In addition, the above related art has implemented an effect of reducing a vibration and a noise acting on a hydraulic unit and an actuator. However, since connection between the cam member and a cylinder member of the pumping device is not firmly achieved, durability may be decreased, so continuous researches and developments are required to solve such a problem.

### DETAILED DESCRIPTION OF THE INVENTION

### Technical Problem

The present invention is made to improve the problems of the direction of motion changing device according to the related art, in which most of conventional direction of motion changing devices are configured in the form of a bevel gear, so that a large energy loss has caused due to engagement between gears.

In particular, since a large friction is generated during the engagement between the gears included in the bevel gear, it is necessary to apply lubricating oil into the direction of motion changing device, and since the gears are easily abraded, the durability of the direction of motion changing device is decreased, so that a main object of the present invention is to provide solutions to the above problems.

### Technical Solution

In order to implement the desired object as described above, the present invention proposes a direction of motion changing device including: a housing formed therein with an inner space; a rotary shaft inserted into the inner space, provided with a rotary plate having a tilted shape, and configured to receive a rotary power of a driving body to rotate; and a linearly reciprocating shaft having one end connected to one side of the rotary plate (30), and having a portion fastened to the housing to linearly reciprocate in a longitudinal direction of the rotary shaft.

### Advantageous Effects of the Invention

According to the direction of motion changing device according to the present invention proposed as described above, the one side of the rotary plate, which is provided in a tilted state on the rotary shaft rotated by the driving body, is connected to the linearly reciprocating shaft, and the linearly reciprocating shaft linearly reciprocates according to a phase change of the rotary plate, so that it is unnecessary to provide a gear unit configured by engagement of gears between gears such as a bevel gear.

In particular, when compared to the direction of motion changing device including the gear unit as described above, according to the direction of motion changing device of the present invention, a noise can be significantly reduced, and a decrease in durability due to the abrasion of the gear can be improved.

### DESCRIPTION OF THE DRAWINGS

FIG. 1 is a perspective view showing a direction of motion changing device according to an exemplary embodiment of the present invention.

FIG. 2 is a perspective view showing a case in which the direction of motion changing device according to the exemplary embodiment of the present invention is applied to a jig saw.

FIG. 3a is a side sectional view showing a case in which a linearly reciprocating shaft of the direction of motion changing device according to the exemplary embodiment of the present invention is lifted.

FIG. 3b is a side sectional view showing a case in which the linearly reciprocating shaft of the direction of motion changing device according to the exemplary embodiment of the present invention is lowered.

FIG. 4 is an exploded perspective view showing the direction of motion changing device according to the exemplary embodiment of the present invention.

FIG. 5 is an exploded perspective view showing a rotary shaft and a rotary plate of the direction of motion changing device according to the exemplary embodiment of the present invention.

FIG. 6 is a perspective view showing the rotary shaft and the linearly reciprocating shaft of the direction of motion changing device according to the exemplary embodiment of the present invention.

FIG. 7 is a perspective view showing lifted and lowered states of the linearly reciprocating shaft according to a rotation process of the rotary plate of the direction of motion changing device according to the exemplary embodiment of the present invention.

FIG. 8 is a perspective view showing a case in which a sliding groove is formed in a housing of the direction of motion changing device according to the exemplary embodiment of the present invention.

FIG. 9 is a plan view showing the linearly reciprocating shaft of the direction of motion changing device according to the exemplary embodiment of the present invention.

### BEST MODE

The present invention relates to a direction of motion changing device capable of converting a rotary motion of a driving body 50 into a linear reciprocating motion, and the direction of motion changing device includes: a housing 10 formed therein with an inner space 11; a rotary shaft 20 inserted into the inner space 11, provided with a rotary plate 30 having a tilted shape, and configured to receive a rotary power of a driving body 50 to rotate; and a linearly reciprocating shaft 40 having one end connected to one side of the rotary plate 30, and having a portion fastened to the housing 10 to linearly reciprocate in a longitudinal direction of the rotary shaft 20.

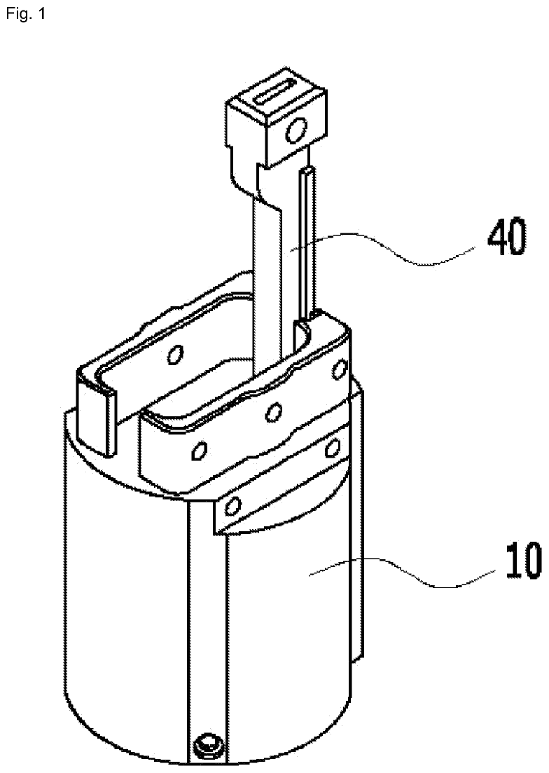

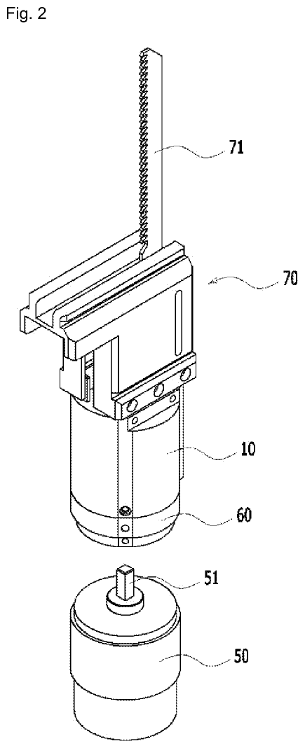

Hereinafter, the present invention will be described in detail with reference to FIGS. 1 to 9 showing embodiments of the present invention.

First, the direction of motion changing device according to the present invention may refer to a device for converting a rotary motion of a rotation shaft 51 provided in the driving body 50, such as a motor, into a linear reciprocating motion, and may refer to a device for converting a predetermined rotary power into a reciprocating force.

In addition, the direction of motion changing device according to the present invention may be mounted on a variety of mechanisms or apparatuses where it is necessary to convert the rotary motion into the linear reciprocating motion as described above. Hereinafter, exemplary embodiment of the present invention will be described with reference to a case in which the direction of motion changing device of the present invention is mounted on a jig saw.

In other words, the direction of motion changing device according to the present invention may mainly include the housing 10, the rotary shaft 20 provided with the rotary plate 30, and the linearly reciprocating shaft 40.

In detail, the housing 10 is a component formed therein with the inner space 11 and serving as a body of the direction of motion changing device according to the present invention.

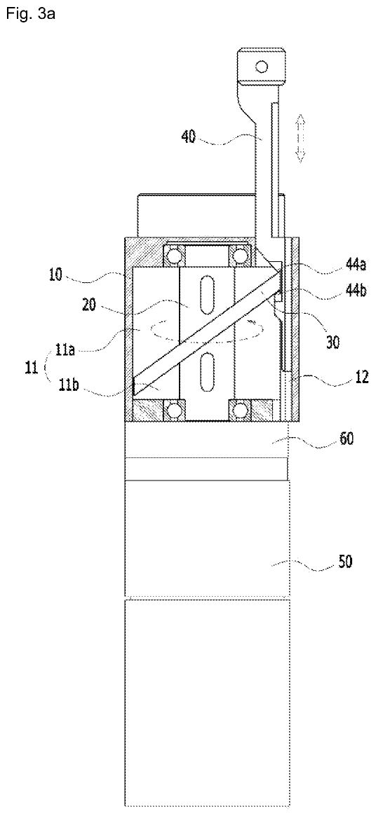

In this case, the rotary shaft 20 and the linearly reciprocating shaft 40 which will be described below may be inserted into the inner space 11 formed in the housing 10 as shown in FIG. 3a, a length of the housing 10 is defined in a direction from a top to a bottom of the housing 10 (hereinafter referred to as “longitudinal direction”) with reference to FIG. 3a, and an inner length of the inner space 11 is defined in the longitudinal direction of the housing 10.

In addition, the housing 10 may be directly fastened to the driving body 50 for providing a rotary power to the direction of motion changing device according to the present invention, and only the rotation shaft 51 provided in the driving body 50 may be inserted into the inner space 11 of the housing 10.

In more detail, a top of a body of a motor, which is the driving body 50, may be fastened to a bottom of the housing 10, and a portion of an upper end of the rotation shaft 51 of the motor may be inserted into the inner space 11 of the housing 10 through the bottom of the housing 10 and connected to a bottom of the rotary shaft 20 which will be described below.

In addition, the housing 10 having the above configuration may serve as a structure directly fastened to the driving body 50 as described above to transmit the rotary power of the driving body 50 to the rotary shaft 20 that will be described below, or an auxiliary housing 60 provided with a connection rotation shaft 61 may be further provided at the bottom of the housing 10.

In other words, the auxiliary housing 60 may be fastened to the bottom of the housing 10, and the top of the driving body 50 is fastened to a bottom of the auxiliary housing 60, so that the auxiliary housing 60 may serve as a connection member for connecting the housing 10 to the driving body 50.

In this case, the connection rotation shaft 61 may be rotatably provided inside the auxiliary housing 60, a top of the connection rotation shaft 61 may be connected to the bottom of the rotary shaft 20 which will be described below, and a bottom of the connection housing 10 may be connected to a top of the rotation shaft 51 of the driving body 50.

Further, at least on bearing may be provided inside the auxiliary housing 60, and the connection rotation shaft 61 may be fastened to the bearing, so that the connection rotation shaft 61 may be smoothly rotatable in the auxiliary housing 60.

In addition, the auxiliary housing 60 may include reduction gears for reducing a rotation speed of the rotation shaft 51 of the driving body 50 to serve as a speed reducer.

Further, the rotary shaft 20 is a component inserted into the inner space 11 of the housing 10, provided with the rotary plate 30 having the tilted shape, and configured to receive the rotary power of the driving body 50 to rotate, and is a component configured to receive the rotary power of the driving body 50 to rotate the rotary plate 30 provided on the rotary shaft 20.

In other words, the rotary shaft 20 is a component connected to the rotation shaft 51 of the driving body 50 (or the connection rotation shaft 61 of the auxiliary housing 60) to receive the rotary power of the driving body 50, and may be inserted into the inner space 11 of the housing 10.

In this case, the rotary shaft 20 may rotate while being inserted in the inner space 11 of the housing 10 in the longitudinal direction, and it is preferable to define a length of the rotary shaft 20 in the same direction as the longitudinal direction of the housing 10 to insert the rotary shaft 20 in the inner space 11 of the housing 10.

In more detail, a predetermined portion of the rotary shaft 20, that is, upper and lower portions of the rotary shaft 20 may be rotatably fastened to upper and lower portions of the inner space 11 of the housing 10. In this case, if the auxiliary housing 60 is further provided to the present invention, the bottom of the rotary shaft 20 may be fastened to the top of the connection rotation shaft 61 provided in the auxiliary housing 60.

In addition, each of the upper and lower portions of the inner space 11 of the housing 10 may be provided with a bearing so that each of the upper and lower portions of the rotary shaft 20 may be easily rotatable.

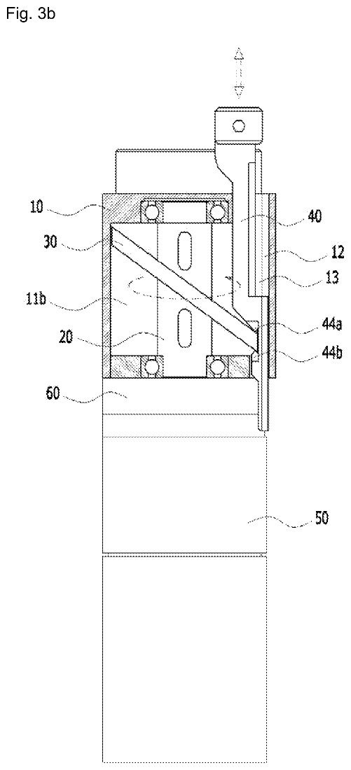

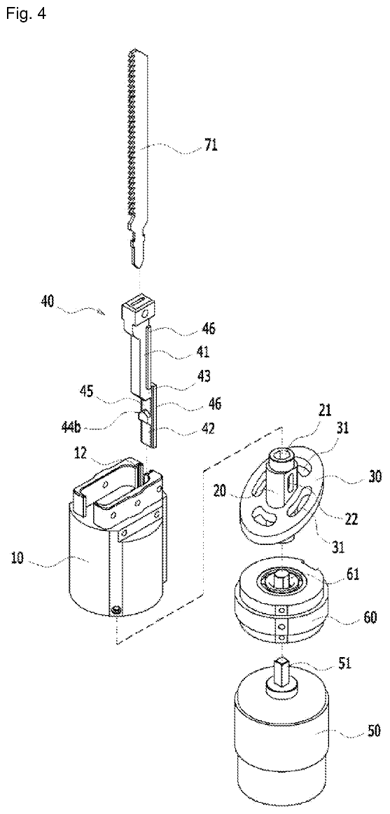

Further, the rotary plate 30 is a component provided on the rotary shaft 20 having the above configuration to rotate by the rotation of the rotary shaft 20, in which as shown in FIGS. 4 and 5, the rotary plate 30 may be fastened to the rotary shaft 20 such that a rotation center of the rotary plate 30 is positioned at a rotation center of the rotary shaft 20, and the rotary plate 30 is tilted in the longitudinal direction of the rotary shaft 20.

In other words, while the rotation center of the rotary plate 30 is positioned at the rotation center of the rotary shaft 20, the rotary plate 30 may be fastened to the rotary shaft 20 in a tilted state such that the one side of the rotary plate 30 is positioned on an upper side of the rotary shaft 20, and the other side of the rotary plate 30, which is opposite to the one side, is positioned on a lower side of the rotary shaft 20.

In more detail, when rotated by the rotary shaft 20, an outer circumference of the rotary plate 30 having the above configuration may have a vertical phase (vertical phase with respect to the longitudinal direction of the rotary shaft 20) that is continuously changed on the basis of one point of the inner space 11 of the housing 10 (portion where one point of the linearly reciprocating shaft 40 that will be described below is positioned). As a result, the linearly reciprocating shaft 40, which will be described below, having one end positioned on the one side of the rotary plate 30 may linearly reciprocate in the longitudinal direction of the rotary shaft 20.

In addition, the outer circumference of the rotary plate 30 having the above configuration is preferably an elliptical outer circumference so as to form the same radius at all timed when the rotary shaft 20 rotates.

Further, the linearly reciprocating shaft 40 is a component having one end connected to the one side of the rotary plate 30, and having a portion fastened to the housing 10 to linearly reciprocate in the longitudinal direction of the rotary shaft 20, and is a component that linearly reciprocates in the longitudinal direction of the rotary shaft 20 according to a vertical phase change of the outer circumference of the rotary plate 30.

In other words, a predetermined portion of the linearly reciprocating shaft 40 may be fastened to the housing 10 so as to be slidably movable, and the one end of the linearly reciprocating shaft 40 may be connected to the one side of the rotary plate 30 so that the linearly reciprocating shaft 40 may slidably move in the housing 10 according to a vertical phase change of the one side of the rotary plate 30. In this case, a direction of the sliding movement of the linearly reciprocating shaft 40 with respect to the housing 10 may be the same as the longitudinal direction of the rotary shaft 20 or the longitudinal direction of the housing 10.

In addition, when the longitudinal direction of the rotary shaft 20 is defined in a vertical direction as shown in FIGS. 3a and 3b, the one side of the rotary plate 30 may refer to a predetermined portion of the rotary plate 30 positioned on a right side in the longitudinal direction of the rotary shaft 20, and does not indicate a specific portion of the rotary plate 30.

Further, a case in which the one side of the rotary plate 30 is connected to the one end of the linearly reciprocating shaft 40 does not refer to connection that the one end of the linearly reciprocating shaft 40 is fixedly fastened to one portion of the rotary plate 30 to allow the linearly reciprocating shaft 40 to rotate together with the rotary plate 30, but may refer to a case in which mutually interfering connection between the predetermined portion (the one side) of the rotary plate 30 positioned on the right side in the longitudinal direction of the rotary shaft 20 and the one end of the linearly reciprocating shaft 40 is maintained as described above.

In addition, the linearly reciprocating shaft 40 may linearly reciprocate in the longitudinal direction of the rotary shaft 20 by the rotary plate 30 which is provided on the rotary shaft 20 in the tilted state to rotate as described above. In this case, a reciprocating distance of the linearly reciprocating shaft 40 may be the same as a vertical phase interval between the top and bottom of the rotary plate 30 having the tilted shape.

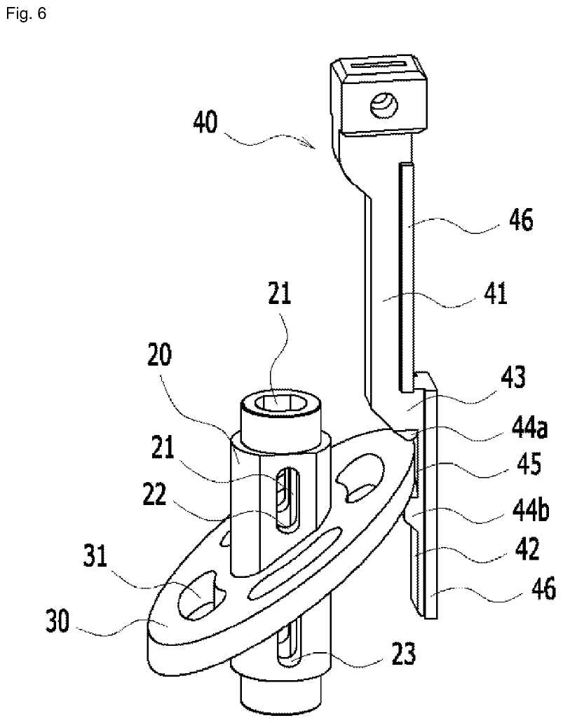

In other words, when an outer circumference of the top of the rotary plate 30 in the tilted state is connected to the one end of the linearly reciprocating shaft 40 as shown in FIG. 7(a), the linearly reciprocating shaft 40 may be lifted toward an upper portion of the rotary shaft 20 in the longitudinal direction, when the rotary plate 30 is rotated so that an outer circumference of a side portion of the rotary plate 30 is connected to the one end of the linearly reciprocating shaft 40 as shown in FIG. 7(b), the linearly reciprocating shaft 40 may be lowered toward a middle from the upper portion of the rotary shaft 20 in the longitudinal direction, and when the rotary plate 30 is further rotated so that an outer circumference of the bottom of the rotary plate 30 is connected to the one end of the linearly reciprocating shaft 40 as shown in FIG. 7(c), the linearly reciprocating shaft 40 may be lowered toward a lower portion from the middle of the rotary shaft 20 in the longitudinal direction.

With regard to the above configuration, the other end of the linearly reciprocating shaft 40 may be drawn out of the housing 10, and the other end of the linearly reciprocating shaft 40 may be fastened to a driven body 70 which receives a linear reciprocating force by the direction of motion changing device according to the present invention. When the present invention is used as a direction of motion changing device mounted on a jig saw, a saw blade 71 may be fastened to the other end of the linearly reciprocating shaft 40.

In addition, according to the present invention, the inner space 11 may be configured such that a vertical section of the inner space 11 with respect to the longitudinal direction of the housing 10 has a circular inner circumference, and the outer circumference of the rotary plate 30 may be configured to rotate in the inner space 11 while making close contact with an inner circumference of the inner space 11.

In other words, when the outer circumference of the rotary plate 30 makes close contact with the inner space 11 of the housing 10 having a circular vertical section as described above, the outer circumference of the rotary plate 30 may rotate while being supported by an inner wall of the inner space 11 at all times. As a result, the rotary plate 30 may rotate more stably in the inner space 11.

In this case, a case in which the outer circumference of the rotary plate 30 makes close contact with the inner wall of the inner space 11 does not refer to a state in which the outer circumference of the rotary plate 30 is tightly fitted to the inner wall of the inner space 11, but may refer to a case in which a suitable clearance is formed so that a friction between the outer circumference of the rotary plate 30 and the inner wall of the inner space 11 may be minimized, and shaking of the rotary plate 30 within the inner space 11 may be minimized.

In addition, while the outer circumference of the rotary plate 30 makes close contact with the inner circumference of the inner space 11, the rotary plate 30 may have at least one vent hole 31 that allows upper and lower portions of the rotary plate 30 to communicate with each other.

In other words, the vent hole 31 may be formed in the rotary plate 30 to penetrate the upper and lower portions of the rotary plate 30, so that air accommodated in the inner space 11, which is partitioned into an upper inner space 11a and a lower inner space 11b by the rotary plate 30, may appropriately flow according to the rotation of the rotary plate 30.

In detail, the inner space 11 of the housing 10 may be partitioned into the upper inner space 11a formed in an upper portion of the rotary plate 30 and the lower inner space 11b formed in a lower portion of the rotary plate 30 by the rotary plate 30 provided in the tilted state on the rotary shaft 20. In this case, the air accommodated in each of the upper and lower inner spaces 11a and 11b may continuously rotate when the rotary plate 30 rotates. Since the rotary plate 30 is provided on the rotary shaft 20 in the tilted state, a continuous pressure change may be generated partially in the air accommodated in each of the upper and lower inner spaces 11a and 11b, and the pressure change may inhibit the rotation of the rotary plate 30 and a cause noise.

In this regard, the vent hole 31 may allow the air to flow from the upper inner space 11a to the lower inner space 11b and from the lower inner space 11b to the upper inner space 11a, so that a pressure difference due to the partial pressure change occurring in the upper inner space 11a and a pressure difference due to the partial pressure change occurring in the lower inner space 11b may be properly resolved.

In addition, while the outer circumference of the rotary plate 30 makes close contact with the inner circumference of the inner space 11, the rotary shaft 20 may have a hollow 21 having a length in the longitudinal direction of the rotary shaft 20, and the hollow 21 may be configured to communicate with an upper hole 22 formed in the rotary shaft 20 corresponding to the upper portion of the rotary plate 30 and a lower hole 23 formed in the rotary shaft 20 corresponding to the lower portion of the rotary plate 30 on the basis of the rotary plate 30.

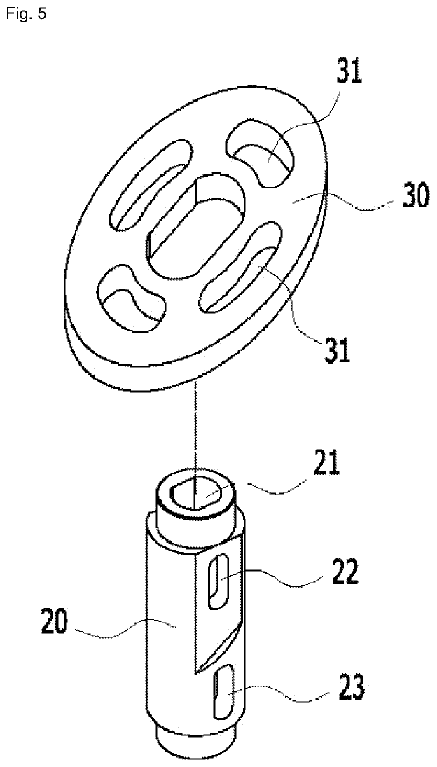

In other words, the hollow 21 may be formed inside the rotary shaft 20 in the longitudinal direction of the rotary shaft 20 as shown in FIG. 6, the upper hole 22 may be formed in an upper side portion of the rotary shaft 20 positioned on the upper portion of the rotary plate 30 to communicate with the hollow 21, and the lower hole 23 may be formed in a lower side portion of the rotary shaft 20 positioned on a lower portion of the rotary plate 30 to communicate with the hollow 21.

In this case, the upper hole 22 may communicate with the upper inner space 11a, and the lower hole 23 may communicate with the lower inner space 11b.

In more detail, the upper inner space 11a, the upper hole 22, the hollow 21, the lower hole 23, and the lower inner space 11b may communicate with each other to allow the air accommodated in each of the upper and lower inner spaces 11a and 11b to communicate with each other when the rotary plate 30 rotates, so that the pressure difference due to the partial pressure change in the inner space 11 generated when the rotary plate 30 rotates may be reduced.

With regard to the above configuration, the hollow 21 may penetrate the top or/and bottom of the rotary shaft 20. In particular, the hollow 21 may penetrate a lower end of the rotary shaft 20, and a top of the rotation shaft 51 of the driving body 50 or a top of the connection rotation shaft 61 of the auxiliary housing 60 may be inserted and fastened to an inlet of the hollow 21 formed at the bottom of the rotary shaft 20, so that the rotary shaft 20 and the driving body 50 or the rotary shaft 20 and the connection rotation shaft 61 may be connected to each other.

In addition, the configuration for resolving the pressure difference due to the partial pressure change in the inner space 11 by the vent hole 31 and resolving the pressure difference due to the partial pressure change in the inner space 11 by the hollow 21 and the upper and lower holes 22 and 23 may be independently configured in the present invention or may be collectively configured in the present invention.

Further, the inner space 11 of the housing 10 may be formed in an inner circumferential surface thereof with a sliding groove 12 having a length in a longitudinal direction of the housing 10, and a portion of the linearly reciprocating shaft 40 may be inserted and fastened to the sliding groove 12 to linearly reciprocate in the longitudinal direction of the rotary shaft 20.

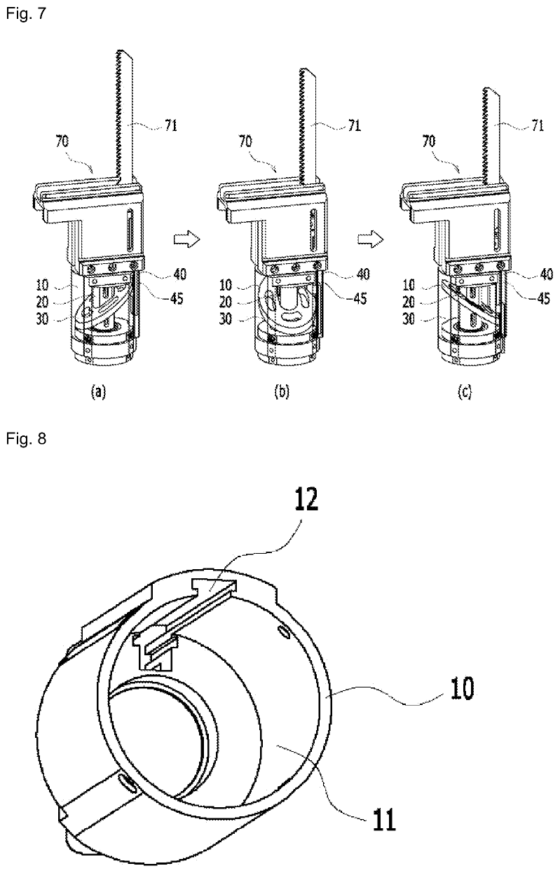

In other words, the sliding groove 12 is a component for fastening the linearly reciprocating shaft 40 to the housing 10 to allow the linearly reciprocating shaft 40 to linearly reciprocate in the longitudinal direction of the rotary shaft 20, and may be recessed by a predetermined depth in the inner circumferential surface of the inner space 11 of the housing 10 as shown in FIG. 8.

In this case, the sliding groove 12 may have the same length as the length of the housing 10, and may have a length equal to or greater than the reciprocating distance of the linearly reciprocating shaft 40.

In addition, the sliding groove 12 may be provided at least one step 13 protruding toward a center of the sliding groove 12 and formed in the longitudinal direction of the sliding groove 12, and the linearly reciprocating shaft 40 may be provided with a corresponding portion 46 having a shape that may be correspondingly inserted into the sliding groove 12 and the step 13, so that the linearly reciprocating shaft 40 may be slidably movable in the longitudinal direction of the rotary shaft 20 without falling out to a side of the sliding groove 12.

Further, when the outer circumference of the rotary plate 30 makes close contact with the inner circumference of the inner space 11 of the housing 10 as described above, an entire portion of the one end of the linearly reciprocating shaft 40 may be inserted into the sliding groove 12, so that a side of the linearly reciprocating shaft 40 may not protrude from the inner circumferential surface of the inner space 11 of the housing 10. However, in this case, the one end of the linearly reciprocating shaft 40 has to be provided with protruding sills 44a and 44b protruding toward the rotary plate 30 in order to connect the one side of the rotary plate 30 to the one end of the linearly reciprocating shaft 40.

In addition, when the sliding groove 12 is formed in the inner circumferential surface of the inner space 11 of the housing 10, and the portion of the linearly reciprocating shaft 40 is inserted into the sliding groove 12 as described above, the linearly reciprocating shaft 40 may include: a lower portion 41 inserted into the sliding groove 12; and an upper portion 42 extending upward from a top of the lower portion 41, and a connection portion 43 between the lower portion 41 and the upper portion 42 may be bent such that the upper portion 42 is positioned closer to a longitudinal central axis of the rotary shaft 20 than the lower portion 41.

In other words, according to the linearly reciprocating shaft 40 having the above configuration, the lower portion 41, which is a portion of the linearly reciprocating shaft 40 inserted in the sliding groove 12 to convert the rotary motion of the rotary plate 30 to the linear reciprocating motion, may be disposed on an outer side of the rotary plate 30 as possible so as to ensure the radius of the rotary plate 30 as large as possible, so that the reciprocating distance of the linearly reciprocating shaft 40 may be extended.

In detail, the rotary plate 30 having the same inclination angle with respect to the rotary shaft 20 may have a greater vertical phase interval between the top and bottom of the rotary plate 30 as the rotary plate 30 has a larger outer circumference (larger radius) about the rotary shaft 20, and accordingly, the reciprocating distance of the linearly reciprocating shaft 40 may be increased. The linearly reciprocating shaft 40 having the above configuration may be configured such that the lower portion 41 is positioned farther from the rotary shaft 20 than the upper portion 42, so that the radius of the rotary plate 30 may be formed as large as possible.

In this case, a bending angle of the connection portion 43 between the lower portion 41 and the upper portion 42 may be appropriately set according to the determination of those skilled in the art, and the upper portion 42 may be position on the upper portion of the rotary plate 30.

In addition, when the upper portion 42 is positioned closer to the central axis of the rotary shaft 20 than the lower portion 41, an interval between the rotary shaft 20 for providing the rotary power of the rotary plate 30 and the upper portion 42 of the linearly reciprocating shaft 40 configured to receive the rotary power of the rotary shaft 20 and the rotary plate 30 to generate the linear reciprocating force may be reduced. As a result, a withdrawn portion of the linearly reciprocating shaft 40 with respect to the housing 10 may be guided to an inner side of the housing 10, so that a volume of the direction of motion changing device according to the present invention may be reduced.

Further, in order to improve the connectivity of a connection portion between the rotary plate 30 and the linearly reciprocating shaft 40 while reducing a frictional force the connection portion and a noise caused by the frictional force, the one end of the linearly reciprocating shaft 40 may be provided with a pair of protruding sills 44a and 44b protruding toward the rotary plate 30, and a portion of the outer circumference of the rotary plate 30 may be inserted into a separation groove 45 formed between the pair of protruding sills 44a and 44b, so that the one end of the linearly reciprocating shaft 40 may be connected to the one side of the rotary plate 30.

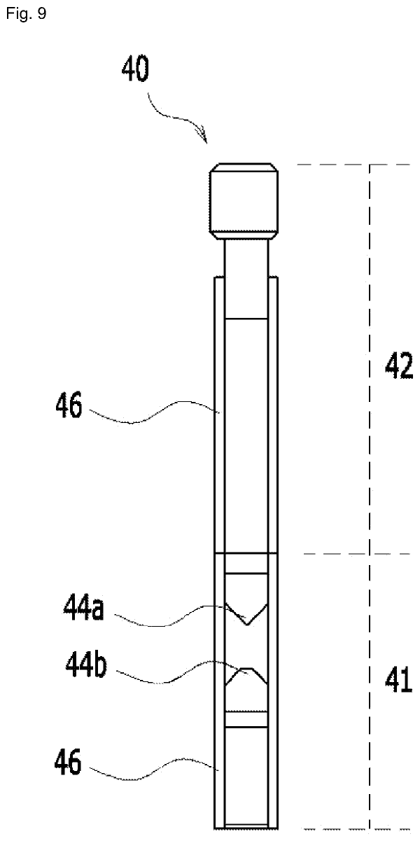

In other words, the pair of protruding sills 44a and 44b are components protruding toward the rotary plate 30 from the one end of the linearly reciprocating shaft 40 as shown in FIGS. 6 and 9, and are components for maintaining a state in which the portion of the outer circumference of the rotary plate 30 rotated by the rotary shaft 20 may be continuously inserted into the separation groove 45 formed between the pair of protruding sills 44a and 44b.

In this case, it will be apparent that a width of the separation groove 45 has to be configured such that the outer circumference of the rotary plate 30 may be inserted in to the separation groove 45, and when the linearly reciprocating shaft 40 is classified into the lower portion 41 and the upper portion 42, the pair of protruding sills 44a and 44b may be provided on a side surface of the lower portion 41.

In detail, the rotary plate 30 may rotate about the rotary shaft 20 while maintaining the state in which the outer circumference is inserted into the separation groove 45, a vertical phase of the rotary plate 30 on a side where the linearly reciprocating shaft 40 is positioned may be continuously changed because the rotary plate 30 has the tilted state. In this case, the pair of protruding sills 44a and 44b provided on the linearly reciprocating shaft 40 may continuously guide a portion of the outer circumference of the rotary plate 30 to the separation groove 45, and may linearly reciprocate the linearly reciprocating shaft 40 in the vertical direction (the longitudinal direction of the rotary shaft 20) according to the vertical phase change of the rotary plate 30.

In addition, among the pair of protruding sills 44a and 44b, one protruding sill 44a positioned on an upper side of the rotary plate 30 may form an interference with the portion of the outer circumference of the top of the rotary plate 30 when the linearly reciprocating shaft 40 is lifted, and, on the contrary, the other protruding sill 44b may form an interference with the portion of the outer circumference of bottom of the rotary plate 30 when the linearly reciprocating shaft 40 is lowered.

Further, at least one of the pair of protruding sills 44a and 44b may have a pointed shape at a side thereof adjacent to the separation groove 45 to make contact with a top or bottom surface of the portion of the outer circumference of the rotary plate 30.

In other words, when the protruding sills 44a and 44b have the pointed shape at the side thereof adjacent to the separation groove 45, and a pointed portion makes contact with the top or bottom surface of the portion of the outer circumference of the rotary plate 30, the protruding sills 44a and 44b may maintain the connection with the rotary plate 30 closely, and a contact area between the protruding sills 44a and 44b and the rotary plate 30 may be reduced, so that the friction between the protruding sills 44a and 44b and the rotary plate 30 may be reduced to prevent friction heat and noise.

In addition, the expression “pointed shape” may refer to a configuration with a corner, but it is more preferable that a corner portion is a rounded.

Further, both the pair of protruding sills 44a and 44b may be have the pointed shape, but as shown in FIG. 9, one protruding sill 44a may have the pointed shape while the other protruding sill 44b makes contact with the portion of the outer circumference of the rotary plate 30 in a larger area as compared with the one protruding sill 44a.

In other words, the other protruding sill 44b having a larger area than the one protruding sill 44a and making contact with the rotary plate 30 may make contact with the portion of the outer circumference of the rotary plate 30 in a larger area, so that a pressing force applied to the protruding sill 44b according to the vertical phase change of the rotary plate 30 may be increased. As a result, the linearly reciprocating force required for lifting or lowering the linearly reciprocating shaft 40 may be increased.

In more detail, when the direction of motion changing device according to the present invention is mounted on a jig saw, the saw blade 71 provided in the jig saw generally has an inclination in one direction. In this case, when the saw blade 71 stands in the vertical direction and the inclination of the saw blade 71 is directed downward as shown in FIG. 4, a cutting force by the saw blade 71 may be mainly generated when the saw blade 71 is lowered downward.

Accordingly, when the other protruding sill 44b having a larger area among the pair of protruding sills 44a and 44b is formed under the one protruding sill 44a, the protruding sill 44b making contact with the bottom surface of the portion of the outer circumference of the rotary plate 30 has a large area, so that a pressing force applied to the other protruding sill 44b by the rotary plate 30 when the lifted linearly reciprocating shaft 40 is lowered may be further increased.

The above description has been given with reference to the exemplary embodiments of the present invention, but the present invention is not limited to the above embodiments. Various modifications can be made to the above embodiments by those skilled in the art to which the invention pertains without departing from the spirit of the present invention.

### INDUSTRIAL APPLICABILITY

The present invention relates to the direction of motion changing device capable of converting a rotary motion of the driving body into a linear reciprocating motion, in which the one side of the rotary plate, which is provided in the tilted state on the rotary shaft rotated by the driving body, is connected to the linearly reciprocating shaft, and the linearly reciprocating shaft linearly reciprocates according to the phase change of the rotary plate, so that it is unnecessary to provide a gear unit configured by engagement of gears between gears such as a bevel gear.

1. A direction of motion changing device comprising:
a housing (10) formed therein with an inner space (11);
a rotary shaft (20) inserted into the inner space (11), provided with a rotary plate (30) having a tilted shape, and configured to receive a rotary power of a driving body (50) to rotate; and
a linearly reciprocating shaft (40) having one end connected to one side of the rotary plate (30), and having a portion fastened to the housing (10) to linearly reciprocate in a longitudinal direction of the rotary shaft (20).

2. The direction of motion changing device of claim 1, wherein the inner space (11) is configured such that a vertical section of the inner space (11) with respect to a longitudinal direction of the housing (10) has a circular inner circumference, and
an outer circumference of the rotary plate (30) is configured to rotate in the inner space (11) while making close contact with an inner circumference of the inner space (11).

3. The direction of motion changing device of claim 2, wherein the rotary plate (30) has at least one vent hole (31) that allows upper and lower portions of the rotary plate (30) to communicate with each other.

4. The direction of motion changing device of claim 2, wherein the rotary shaft (20) has a hollow (21) having a length in the longitudinal direction of the rotary shaft (20), and
the hollow (21) is configured to communicate with an upper hole (22) formed in the rotary shaft (20) corresponding to an upper portion of the rotary plate (30) and a lower hole (23) formed in the rotary shaft (20) corresponding to a lower portion of the rotary plate (30) on a basis of the rotary plate (30).

5. The direction of motion changing device of claim 1, wherein the inner space (11) of the housing (10) is formed in an inner circumferential surface thereof with a sliding groove (12) having a length in a longitudinal direction of the housing (10), and
the portion of the linearly reciprocating shaft (40) is inserted and fastened to the sliding groove (12) to linearly reciprocate in the longitudinal direction of the rotary shaft (20).

6. The direction of motion changing device of claim 5, wherein the linearly reciprocating shaft (40) includes:
a lower portion (41) inserted into the sliding groove (12); and
an upper portion (42) extending upward from a top of the lower portion (41), and
a connection portion (43) between the lower portion (41) and the upper portion (42) is bent such that the upper portion (42) is positioned closer to a longitudinal central axis of the rotary shaft (20) than the lower portion (41).

7. The direction of motion changing device of claim 1, wherein the one end of the linearly reciprocating shaft (40) is provided with a pair of protruding sills (44a, 44b) protruding toward the rotary plate (30), and a portion of an outer circumference of the rotary plate (30) is inserted into a separation groove (45) formed between the pair of protruding sills (44a, 44b), so that the one end of the linearly reciprocating shaft (40) is connected to the one side of the rotary plate (30).

8. The direction of motion changing device of claim 7, wherein at least one of the pair of protruding sills (44a, 44b) has a pointed shape at a side thereof adjacent to the separation groove (45) to make contact with a top or bottom surface of the portion of the outer circumference of the rotary plate (30).
